(19) United States
(12) Patent Application Publication
(10) Pub. No.: US 2007/0094884 A1
(43) Pub. Date: May 3, 2007

(54) Golf club grip dryer

(76) Inventor: Michael Micheludis, Warren, NJ (US)

Correspondence Address: JAMES RAY & ASSOCIATES, 2640 PITCAIRN ROAD, MONROEVILLE, PA, 15146, US

(21) Appl. No.: 11/584,739

(22) Filed: Oct. 20, 2006

Related U.S. Application Data
(60) Provisional application No. 60/732,814, filed on Nov. 2, 2005.

(51) Int. Cl. F26B 25/00; F26B 25/06

(52) U.S. Cl. 34/107; 34/202

(57) ABSTRACT

A device for drying moisture disposed on a handle grip of a golf club. The device includes a housing member having an open first end and a closed second end. A first mechanism is disposed within the housing member adjacent the open end thereof for generating airflow. A second mechanism is connected to the first mechanism for operating the first mechanism at a pre-selected speed. A grate member is connected to the open end of the housing member on a first side thereof for allowing air passage therethrough. A tubular member is connected at a first end thereof to a second side of the grate member for receiving a golf club grip therein to be dried by the airflow.

### CROSS REFERENCE TO RELATED APPLICATION

This application is closely related to and claims benefit from U.S. Provisional Patent Application Ser. No. 60/732,814, filed on Nov. 2, 2005.

### FIELD OF THE INVENTION

The present invention relates, in general, to devices used to dry moisture disposed on predetermined objects and, more particularly, the invention relates to a device for drying moisture disposed on a golf club grip.

### BACKGROUND OF THE INVENTION

Prior to the conception and development of the present invention, as is generally well known in the prior art, golfers have been seeking ways to keep the grip portion of their golf clubs dry during play. Being able to grip a golf club without it slipping from the hands is an important aspect to any golf swing.

Golf club grips can become wet out on the golf course for various reasons. Some obvious reasons are rainwater, laying a golf club down on wet grass, perspiration or beverage condensation on a golfer's hands being transferred to the grip, etc. Golfers often use a towel to try and dry their hands and grips. However, the towel often becomes saturated with moisture to where it becomes ineffective in drying either their hands or grips.

One known device for drying golf club handles in the prior art is taught in U.S. Pat. No. 4,934,066. Disclosed therein is a golf club handle drying device comprising a tubular piece that is closed at a first end and open at a second end, a cap, a desiccant, and means for removing desiccant from the golf club handle. A wet golf handle is dried by placing it in the tubular piece in contact with the desiccant.

U.S. Pat. No. 5,873,178 discloses a portable hand dryer for drying wetness from an individual's hands as well as from the instruments or objects being held in their hands. The portable hand dryer includes a casing having an upper housing defining a through opening and a lower housing defining an interior cavity, an air current generator disposed within the through opening of the upper housing, a motor received in the inner cavity of the lower housing, and at least one control to operate the hand dryer. In operation, manipulation of the control activates the motor to power the air current generator to create an air current to dry an object placed within the stream of that current.

However, none of the above noted prior art devices disclose a device specifically designed for drying a golf club grip according to the present invention described in greater detail below.

### SUMMARY OF THE INVENTION

The present invention provides a device for drying moisture disposed on a golf club grip. The device includes a generally hollow housing member formed from a first predetermined material and having each of a predetermined shape and a predetermined size. The housing member is open at a first end and closed at a second end thereof. A first means is disposed within the housing member adjacent the open end thereof for generating a flow of air. A second means is connected to the first means for operating such first means at a pre-selected speed. A grate like member, formed from a second predetermined material and having a pre-selected number of perforations formed therethrough, is connected to the open end of the housing member on a first side thereof for allowing air passage therethrough. Finally, a generally hollow tubular member, formed from a third predetermined material, is connected at a first end thereof to a second side of the grate like member for receiving the golf club grip therein to be dried by such airflow.

### OBJECTS OF THE INVENTION

It is, therefore, one of the primary objects of the present invention to provide a device for drying moisture disposed on a golf club grip to aid in a golf swing.

Another object of the present invention is to provide a golf club grip drying device that can be easily attached directly to a golf bag and rotate while attached thereto for inserting the golf club grip therein at a predetermined angle.

Still another object of the present invention is to provide a golf club grip drying device that can supply a flow of air that is cool or heated depending on the type of airflow that is needed to dry the golf club grip.

Yet another object of the present invention is to provide a golf club grip drying device which is easy to use.

Even another object of the present invention is to provide a golf club grip drying device that is simple in design.

In addition to the above described objects and advantages of the present invention, various additional objects and advantages of the golf club grip dryer according to the instant invention will become more readily apparent to those persons skilled in the relevant art from the following more detailed description, particularly, when such description is taken in conjunction with the attached drawing figures and with the appended claims.

### BRIEF DESCRIPTION OF THE DRAWINGS

FIG. 1 is a side elevation view, partially in cross section, of the golf club grip dryer according to the present invention showing the various components of the device; and

FIG. 2 is a perspective view of the golf club grip dryer, illustrated in FIG. 1, showing the device attached to a golf bag.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity in understanding the invention, identical components having identical functions have been identified with identical reference numerals throughout the several views illustrated in the drawings.

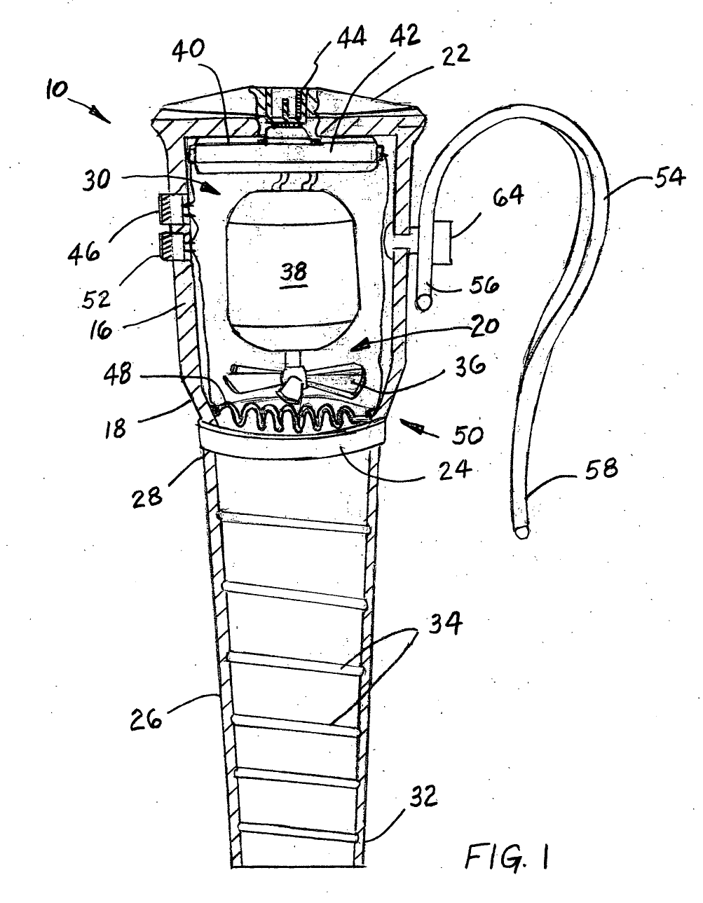

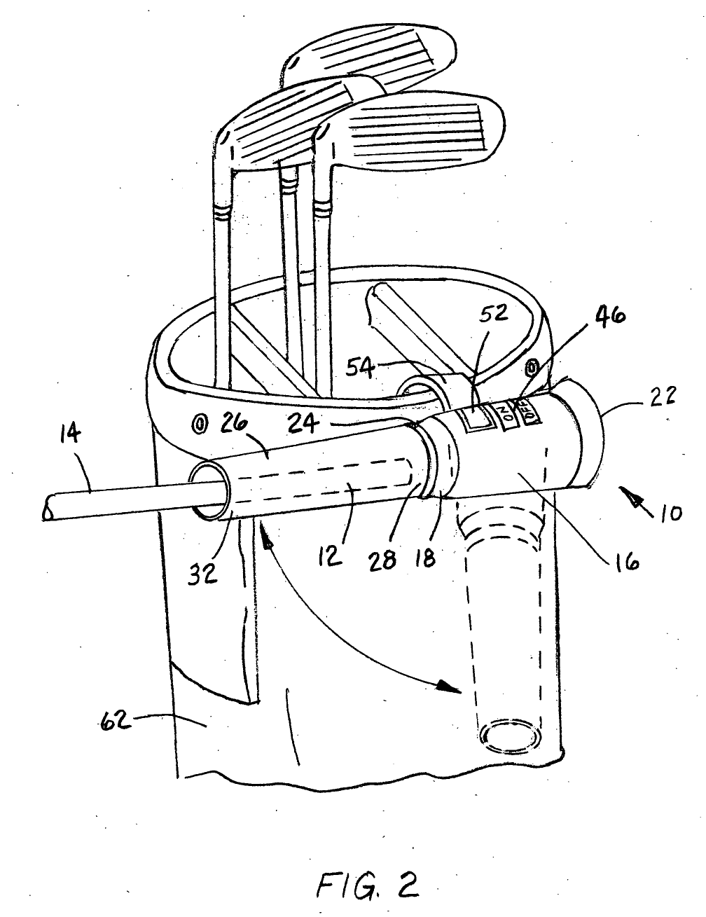

Now reference is made, more particularly, to the drawing FIGS. 1 and 2. Illustrated therein is a device, generally designated 10, for drying moisture disposed on a handle grip 12, shown in dashed outline in FIG. 2, of a golf club 14. The device 10 includes a generally hollow housing member 16 formed from a first predetermined material and having each of a predetermined shape and a predetermined size. Housing member 16 is open at a first end 18 and closed at a second end 22 thereof.

A first means, generally designated 20, is disposed within the housing member 16 adjacent the open end 18 thereof for generating airflow. A second means, generally designated 30, is connected to the first means 20 for operating the first means 20 at a pre-selected speed.

A grate like member 24, formed from a second predetermined material and having a pre-selected number of perforations formed therethrough, is connected to the open end 18 of the housing member 16 on a first side thereof for allowing airflow therethrough.

A generally hollow tubular member 26, formed from a third predetermined material, is connected at a first end 28 thereof to a second side of the grate like member 24 for receiving the golf club grip 12 therein to be dried by such airflow.

Each of the first, second and third predetermined materials will preferably be durable, water resistant materials, such as various types of plastic or rubber. Also, it is preferred that each of such first, second and third predetermined materials used be substantially identical.

In a presently preferred embodiment, the housing member 16, grate like member 24 and tubular member 26 will be adhesively bonded together. However, it is within the scope of this invention that the housing member 16, grate like member 24 and tubular member 26 could be threadedly connected together in a well known manner.

In another presently preferred embodiment, the tubular member 26 will be wider at the first end 28 connected to the grate like member 24 than at a second end 32 that receives such golf club grip 12, and interior surface walls of the tubular member 26 will have ribs 34 for promoting better airflow around such golf club grip 12.

The first means 20 of device 10 will preferably include a unidirectional fan 36. The second means 30 will preferably include a motor 38 and a power source, generally designated 40, for supplying energy to the motor 38 for operating the unidirectional fan 36.

The power source 40 can be an electric power source such as one of a rechargeable battery 42 and a non-rechargeable battery (not shown) that can be removed from the housing member 16 through the closed end 22 thereof.

In still another presently preferred embodiment, the power source 40 will be the rechargeable battery 42. The device 10 will further include at least one electrical contact 44 on and extending through a predetermined surface of housing member 16 to conduct electrical current from an external power source (not shown) to the rechargeable battery 42.

The device 10 preferably includes a first control switch 46 disposed on an outside surface of the housing member 16 for activating the power source 40 to energize the motor 38.

In yet another presently preferred embodiment of the invention, the device 10 further includes a third means, generally designated 50, disposed between unidirectional fan 36 and the grate like member 24 for heating such airflow generated by the unidirectional fan 36. The third means 50 will preferably include at least one heating coil 48.

The device 10 will preferably include a second control switch 52 disposed adjacent the first control switch 46 for activating the power source 40 to energize the at least one heating coil 48.

The device 10 may include a clip member 54 having a first end 56 and a second end 58. The first end 56 is engageable with the housing member 16 and the second end 58 clips the device 10 to a golf bag 62. The clip member 54 may include a swivel member 64 connected to housing member 16 and the first end 56 of clip member 54 for allowing the device 10 to swivel or rotate at least about 90° while being clipped on the golf bag 62.

While a presently preferred and various alternative embodiments of the present invention have been described in detail above it should be understood that various other embodiments of the invention can be envisioned by those persons skilled in the relevant art without departing from the spirit of the invention or the scope of the appended claims.

I claim:

1. A device for drying moisture disposed on a handle grip of a golf club, said device comprising:
(a) a generally hollow housing member formed from a first predetermined material and having each of a predetermined shape and a predetermined size, said housing member being open at a first end and closed at a second end thereof;
(b) a first means disposed within said housing member adjacent said open end thereof for generating a flow of air;
(c) a second means connected to said first means for operating said first means at a pre-selected speed;
(d) a grate like member, formed from a second predetermined material and having a pre-selected number of perforations formed therethrough, connected to said open end of said housing member on a first side thereof for allowing air passage therethrough; and
(e) a generally hollow tubular member, formed from a third predetermined material, connected at a first end thereof to a second side of said grate like member for receiving a golf club grip therein to be dried by said airflow.

2. A device, according to claim 1, wherein each of said first, second and third predetermined materials are durable, water resistant materials.

3. A device, according to claim 1, wherein each of said first, second and third predetermined materials are substantially identical.

4. A device, according to claim 1, wherein said housing member, said grate like member and said tubular member are adhesively bonded together.

5. A device, according to claim 1, wherein said tubular member is wider at said first end connected to said grate like member than at a second end that receives such golf club grip for promoting better airflow around such golf club grip.

6. A device, according to claim 1, wherein interior surface walls of said tubular member are ribbed for promoting better airflow around such golf club grip.

7. A device, according to claim 1, wherein said first means includes a unidirectional fan.

8. A device, according to claim 7, wherein said second means includes a motor and a power source for supplying energy to said motor for operating said unidirectional fan.

9. A device, according to claim 8, wherein said power source is an electric power source.

10. A device, according to claim 9, wherein said electric power source is one of a rechargeable battery and a non-rechargeable battery.

11. A device, according to claim 10, wherein said rechargeable battery is removable from said housing member through said closed end thereof.

12. A device, according to claim 10, wherein said non-rechargeable battery is removable from said housing member through said closed end thereof.

13. A device, according to claim 10, wherein said electric power source is said rechargeable battery.

14. A device, according to claim 13, wherein said device further includes at least one electrical contact on and extending through a predetermined surface of said housing member to conduct electrical current from an external power source to said rechargeable battery.

15. A device, according to claim 9, wherein said device further includes a first control switch disposed on an outside surface of said housing member for activating said electric power source to energize said motor.

16. A device, according to claim 15, wherein said device further includes a third means disposed between said unidirectional fan and said grate like member for heating said airflow generated by said unidirectional fan.

17. A device, according to claim 16, wherein said third means includes at least one heating coil.

18. A device, according to claim 17, wherein said device further includes a second control switch disposed adjacent said first control switch for activating said electric power source to energize said at least one heating coil.

19. A device, according to claim 1, wherein said device further includes a clip member having a first end and a second end, said first end engageable with said housing member and said second end for attaching said device to a golf bag.

20. A device, according to claim 19, wherein said clip member includes a swivel member connected to said housing member and said first end of said clip member for allowing said device to swivel at least about 90°.
